(19) United States
(12) Patent Application Publication
(10) Pub. No.: US 2026/0223891 A1
(43) Pub. Date: Aug. 6, 2026

(54) FIBER BLEND COMPOSITIONS AND METHODS OF USE THEREOF

(71) Applicant: Animal Microbiome Analytics, Inc., Oakland, CA (US)

(72) Inventors: Katie Dahlhausen, Oakland, CA (US); Holly H. Ganz, Oakland, CA (US); Connie A. Rojas, Oakland, CA (US)

(21) Appl. No.: 19/531,099

(22) Filed: Feb. 5, 2026

Related U.S. Application Data
(60) Provisional application No. 63/754,553, filed on Feb. 5, 2025.

(51) Int. Cl. A23K 50/40; A23K 10/12; A23K 10/37; A23K 20/20

(52) U.S. Cl. CPC A23K 50/40; A23K 10/12; A23K 10/30; A23K 10/37; A23K 20/163; A23K 20/30

(57) ABSTRACT

Disclosed herein are compositions and methods of using a fiber-blend composition for improving gastrointestinal (gut) health in companion mammals. The fiber blend compositions comprise multiple types of fiber that differ in their fermentation rates and/or the location of their fermentation along the gastrointestinal tract of the companion mammal. The fiber blend compositions comprise two or more of a slow-fermenting fiber (e.g., arabinogalactan), a moderate fermenting fiber (e.g., beet-derived fiber) and a fast-fermenting fiber (e.g., mannan-oligosaccharides (MOS)). Administration of the compositions can increase taxonomic richness of the gut microbiome. Methods of use are provided.

### CROSS-REFERENCE TO RELATED APPLICATIONS

This application claims the benefit of U.S. Provisional Application Ser. No. 63/754,553, filed Feb. 5, 2025, which is hereby incorporated by reference herein in its entirety.

### BACKGROUND

A variety of dietary measures are recognized to foster a healthy gut microbiota in both humans and their companion mammals. For example, diets higher in fiber, higher in protein, and/or lower in carbohydrates and fats may be beneficial for the gut microbiome, provide better nutrition, and support digestive (gut) and overall health.

High fiber foods may be undesirable or unpalatable to some individuals and/or not readily and consistently available. Addition of a fiber source, e.g., psyllium husks, to an existing diet can provide some benefits of a diet characterized by high-fiber foods. The benefits of such supplements are limited and their use can have negative side effects.

### SUMMARY

The present disclosure discloses dietary fiber compositions comprising at least two or at least three fibers that differ in their fermentation rates and/or their locations of fermentation in the digestive tract, for example, at least two, or at least each, of: a fast-fermenting fiber, a moderate-fermenting fiber and a slow-fermenting fiber. The dietary fiber compositions as described herein can be administered to a companion animal, for example, a dog or a cat. Administration of the disclosed dietary fiber compositions can modulate the recipient's gastrointestinal (gut) microbiome, reduce gastrointestinal dysbiosis, and/or maintain or promote the gastrointestinal health of the animal.

In some embodiments, the dietary fiber compositions comprise a moderate-fermenting fiber or a fast-fermenting fiber, and a slow-fermenting fiber. In some embodiments, the dietary fiber compositions comprise a slow-fermenting fiber or a moderate-fermenting fiber, and a fast-fermenting fiber. In some embodiments, the dietary fiber compositions comprise a slow-fermenting fiber and a moderate-fermenting fiber. In some embodiments, the dietary fiber compositions comprise a slow-fermenting fiber, a moderate-fermenting fiber and a fast-fermenting fiber.

In some embodiments, the fiber components of the fiber compositions consist of a moderate-fermenting fiber or a fast-fermenting fiber, and a slow-fermenting fiber. In some embodiments, the fiber components of the fiber compositions consist of a slow-fermenting fiber or a moderate-fermenting fiber, and a fast-fermenting fiber. In some embodiments, the fiber component of the fiber compositions consist of a slow-fermenting fiber and a moderate-fermenting fiber. In some embodiments, the fiber components of the fiber compositions consist of a slow-fermenting fiber, a moderate-fermenting fiber, and a fast-fermenting fiber.

In some embodiments, the slow-fermenting fiber is selected from arabinogalactan (e.g., larch-derived arabinogalactan), bran (e.g., wheat, corn, rice, rye, oat or the like), resistant starches, and combinations thereof. In some embodiments, the moderate-fermenting fiber is selected from beet-derived fiber (e.g., beet root), konjac root fiber, mannan-oligosaccharides (MOS), and combinations thereof. In some embodiments, the moderate-fermenting fiber is pumpkin or pumpkin-derived. In some embodiments, the fast-fermenting fiber is selected from selected from fructo-oligosaccharides (FOS), mannan-oligosaccharides (MOS), psyllium husk, pectin, inulin, chicory root, Jerusalem artichoke, components of beet fiber, and combinations thereof.

In some embodiments, the fiber composition comprises arabinogalactan or an extract of larch tree (e.g., larch tree arabinogalactan), beet-derived fiber (e.g., an extract of beetroot, dried beet pulp, dehydrated beet root powder), and mannan-oligo-saccharides (MOS), or variants thereof. In some embodiments, the fiber components of the fiber compositions consist of arabinogalactan and/or an extract of larch tree (e.g., larch tree arabinogalactan), beet-derived fiber (e.g., an extract of beetroot, dried beet pulp, dehydrated beet root powder), and mannan-oligo-saccharides (MOS), or variants thereof. In some embodiments, the variants thereof are selected from rabinogalactan (e.g., from larch tree fiber); rabinoxylan (e.g., psyllium seed husk powder); glucomannans (e.g., from konjac root); arabinoxylan (e.g., from oats); chicory root or Jerusalem artichoke or both; mannooligosaccharides (MOS); and cellulose powder.

In some embodiments of the fiber compositions, a fast-fermenting dietary fiber (e.g., mannan-oligosaccharides) is present in an amount of about 5 wt % to about 15 wt % of the fiber components of the composition, a moderate-fermenting fiber (e.g., beet-derived fiber) is present in an amount of about 35 wt % to about 55 wt % of the fiber components of the composition, and a slow-fermenting dietary fiber (e.g., arabinogalactan) is present in an amount of about 35 wt % to about 55 wt % of the fiber components of the composition.

In some embodiments, the dietary fiber compositions produce higher microbial species richness relative to an otherwise identical composition comprising only one fast-fermenting dietary fiber, moderate-fermenting dietary fiber, or slow-fermenting dietary fibers, for example, only one of a fast-fermenting dietary fiber, a moderate-fermenting dietary fiber, and/or a slow-fermenting dietary fibers present in the dietary fiber composition. In some embodiments, the dietary fiber compositions results in higher relative abundance of Lachnospiraceae and/or Ruminococcaceae relative to an otherwise identical composition comprising no dietary fiber.

In some embodiments, the dietary fiber compositions disclosed herein are formulated for mixing with food (solid and/or liquid) and/or water, e.g., as a powdered or particulate solid. In some embodiments, the dietary fiber compositions disclosed herein further comprise an acceptable carrier. In some embodiments, the dietary fiber compositions disclosed herein are provided in combination with food or as a unit-dose dietary supplement.

In another aspect, this disclosure provides a method of supporting gastrointestinal health in a companion animal, the method comprising administering to the animal a fiber composition as disclosed herein. In some embodiments, administration of the fiber composition increase richness or diversity of the gut microbiome. In some embodiments, administration of the fiber composition supports bowel regularity and/or stool-consistency.

The method can comprise daily administration of the fiber composition, e.g., for at least 30 days. The method can comprise administration of an effective amount of the fiber composition, e.g., based on animal weight, tolerances, and/or diet composition. For example, the effective amount of the dietary fiber composition can be about 0.3 g to about 3 g per daily dose, based on body weight of the companion animal.

In some embodiments, the companion animal is a cat. In some embodiments, the companion animal is a dog. In some embodiments, the companion animal is a cat or a dog.

### BRIEF DESCRIPTION OF THE DRAWINGS

FIG. 1 shows early-phase (T0-T24) increase in species richness by fiber dose (1 fiber (B, L, or M); 2 fibers (B+L, B+M, or L+M); 3 fibers (B+L+M), where M-mannan-oligosaccharides (MOS), B=dehydrated beet pulp fiber, and L=larch-derived arabinogalactan) in fecal material from dogs with dysbiosis (n=3) in an in vitro stool assay. Points represent mean increases across donors with SEM. Donors show small but progressively greater early increases with increasing fiber complexity.

FIG. 2 shows early-phase (T0-T24) relative abundance of Lachnospiraceae and/or Ruminococcaceae by fiber dose (1 fiber (B, L, or M); 2 fibers (B+L, B+M, or L+M), and 3 fibers (B+L+M)) relative to an otherwise identical composition comprising no dietary fiber in an in vitro stool assay.

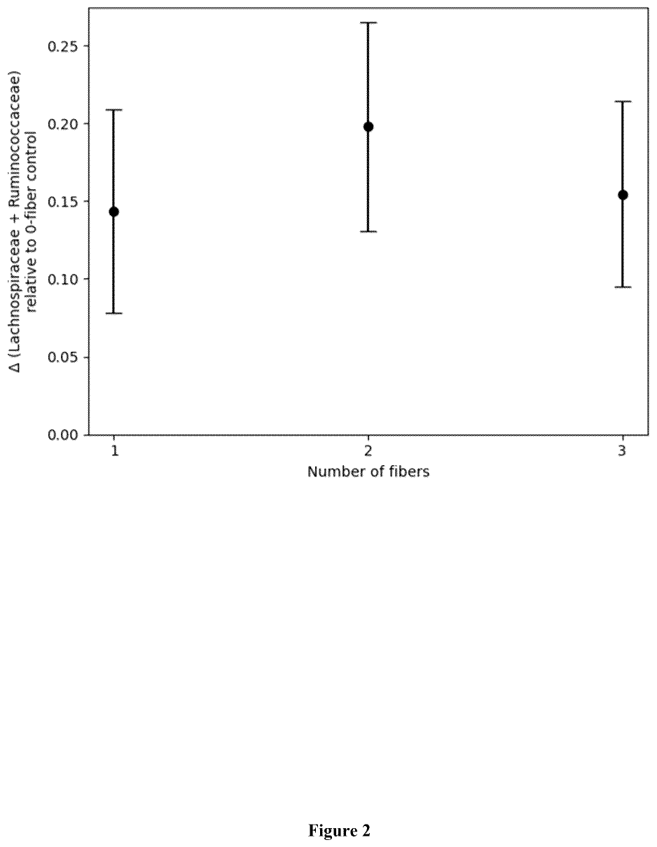

### DETAILED DESCRIPTION

Diet has a profound effect on the microbiome, including its composition and function. Dietary fibers are hydrolyzed in the gastrointestinal tract (gut) by microbes, and high-fiber, high-protein, and low-carbohydrate diets are believed to promote healthy gut microbiomes in animals, including companion mammals such as dogs and cats. Healthy gut microbiomes may in turn provide nutritional benefits, reduce or prevent gastrointestinal dysbiosis, and support (promote and/or maintain) gastrointestinal health.

Fiber can be added to a diet, for example, the existing diet, of a companion mammal. There are commercially available fiber supplements that can be administered to companion mammals. However, these products can have unfavorable side effects and, even when helpful, they do not comprise or provide the benefits of a full-spectrum or complete fiber blend as described herein.

For example, many commercially available fiber supplements contain highly processed ingredients that may be poorly tolerated by dogs and/or cats with gastrointestinal sensitivity, potentially exacerbating clinical signs and diminishing intended benefits. In addition, some formulations rely on pumpkin or pumpkin-derived ingredients, which may deliver amounts or forms of soluble fiber that are poorly tolerated in sensitive dogs and/or cats, particularly when fermentation is inefficient. In such cases, fermentation may be associated with increased gas production, bloating, or loose stool rather than beneficial microbial metabolites. Accordingly, there is a need for fiber supplements comprising naturally derived ingredients and/or reduced potential of an adverse inflammatory response, and that are not dependent on pumpkin-based ingredients as a primary source of fermentable fiber.

In addition, many fiber supplements on the market are focused on or consist of fast-fermenting fibers, such as psyllium husk (e.g., Metamucil). Fermentation is a process in which bacteria break down carbohydrates into short-chain fatty acids (SCFAs), gases (including methane and carbon dioxide), and other metabolites. Fast-fermenting fibers are rapidly broken down by gut microbes. Because they are quickly and readily processed, they are typically fermented in a concentrated area of the proximal intestine, e.g., the distal small intestine and/or upper colon.

Fast-fermenting fibers are often low in cost and can help animal health, but their benefits are limited. In particular, they tend to have localized effects on the gastrointestinal (GI) tract of the animals, once administered. For example, their fast and localized fermentation can concentrate gaseous by-products of the fermentation, so animals may experience negative side effects such as gas, bloating or discomfort. Also for example, their fast and localized fermentation may preclude beneficial effects of fiber on the microbiota in other areas of the GI tract. Generally, supplementation of the diet with fibers having similar fermentation characteristics, for example, one or more kinds of fast-fermenting fiber, will have increased risk of side effects and/or limited effects on the gut microbiota, and hence limited beneficial effects on nutrition, reduction of dysbiosis, and general health. There is a need for fiber supplements that are more structurally complex, and which are gentle, with mild and comprehensive effects on the digestive tracts of companion mammals.

A full-spectrum or complete fiber supplement, as described herein, provides microbiome support over extended regions of the gut, with benefits for gut health (e.g., reduced incidents of dysbiosis) as well as potential and consequential benefits for nutrition and overall health of the companion mammal. A full-spectrum or complete fiber supplement, as described herein, provides more mild and comprehensive effects on the digestive tracts of companion mammals than existing supplements. Yet further, a full-spectrum or complete fiber supplement, as described herein, can comprise naturally derived ingredients and/or low amounts of allergens, and, further, can be devoid of pumpkin.

A full-spectrum or complete fiber supplement, as described herein, comprises multiple (two or more) types of fiber differ in their fermentation rates. While fermentation rates of fiber by gut microbes can vary depending on conditions, including for example the gut microbiome, host condition, and gut contents, fermentation rates also depend on physicochemical aspects of the fiber itself. For example, fibers may be soluble or insoluble, with the latter generally being more resistant to fermentation. But other physicochemical features of fiber, such as their cellular structure and molecular size, may also affect their digestion. See Williams B A, et al., “Gut Fermentation of Dietary Fibres: Physico-Chemistry of Plant Cell Walls and Implications for Health,” Int J Mol Sci. 2017 Oct. 20; 18(10):2203; Holscher, H. D. “Dietary fiber and prebiotics and the gastrointestinal microbiota.” Gut Microbes 2017, 8, 172-184 (each incorporated herein by reference).

As used herein, “rate of fermentation” or “fermentation rate” refers to the rate at which a type of fiber is typically broken down by gut bacteria in the GI tract of an animal and can be determined by any appropriate in vitro model or assay, controlling for conditions, as would be known to one of skill in the art and as described, for example, by Wang W, et al. “In vitro colonic fermentation of dietary fibers: Fermentation rate, short-chain fatty acid production and changes in microbiota,” Trends in Food Sci. & Tech. 2019 June; 88:1-9; doi: 10.1016/j.tifs.2019.03.005) (incorporated herein by reference).

Fibers can be categorized by their fermentation rates, with such rates falling generally into sequential categories of slow, moderate and fast fermentation rates. See, e.g., Moncada, E.; et al, “Dietary Fiber's Physicochemical Properties and Gut Bacterial Dysbiosis Determine Fiber Metabolism in the Gut,” Nutrients 2024, 16, 2446; doi: 10.3390/nu16152446 (incorporated herein by reference). As used herein, these categories encompass the full range of fermentation rates (as measured by an appropriate in vitro assay) for recognized dietary fibers (as defined by the CODEX Alimentarius Commission in Codex Alimentarius Committee, “Guidelines on nutrition labelling CAC/GL 2-1985” as last amended 2010. Joint FAO/WHO Food Standards Programme, Secretariat of the Codex Alimentarius Commission. Rome, Italy: FAO. 2010).

As used herein, the term “fast-fermenting fiber” refers generally to dietary fibers characterized by fermentation rates that are above the mean rate of fermentation for an exemplary range of recognized dietary fibers, and encompasses fibers having the fastest observed rates of fermentation (as measured by an appropriate in vitro assay). Fast-fermenting fibers include, without limitation, psyllium (e.g., psyllium husk), fructo-oligosaccharides (FOS), pectin, inulin, material derived from chicory root, material derived from Jerusalem artichoke, galacto-oligosaccharides (GOS), beta-glucans, mannan-oligosaccharides (MOS), and a subset of fibers present in whole foods with a diverse matrix of dietary fibers, as well as fibers having physicochemical features and/or rates of fermentation similar thereto. Fermentation of fast-fermenting fibers tends to occur in the most proximal regions of the intestine suitable for fermentation, e.g., the distal extent of the small intestine and/or upper colon. Fast-fermenting fibers may begin fermenting more quickly (earlier) than other fibers and/or may be fully fermented more quickly.

For example, fermentation of MOS is biphasic, beginning very early in the proximal colon, but being rate-limited by enzymes. Once it has been depolymerized, the resulting oligosaccharides are fermented very quickly into SCFAs. This biphasic fermentation allows for a more controlled production of SCFA, which minimizes side effects and is better tolerated by animals with sensitivities.

As used herein, the term “slow-fermenting fibers” refers generally to dietary fibers characterized by fermentation rates that are below the mean rate of fermentation for an exemplary range of recognized dietary fibers, and encompasses fibers having among the slowest observed rates of fermentation (as measured by an appropriate in vitro assay). Slow-fermenting fibers include, without limitation arabinogalactan (e.g., larch-derived arabinogalactan), all forms of bran (e.g., wheat, corn, rice, rye, oat or the like), resistant starches (e.g., green banana), and a subset of fibers present in whole foods with a diverse matrix of dietary fibers, as well as fibers having physicochemical features and/or rates of fermentation similar thereto. Slow-fermenting fibers include insoluble fibers as well as soluble fibers that have low fermentation rates relative to other common dietary fibers. Fermentation of slow-fermenting fibers occurs in areas including the most distal regions of the intestine, e.g., the colon and lower colon.

As used herein, the term “moderate-fermenting fibers” refers generally to dietary fibers characterized by fermentation rates below those of fast-fermenting fibers and/or above those of slow-fermenting fibers, and encompasses fibers having rates statistically similar to mean or median rates of fermentation for an exemplary range of recognized dietary fibers, for example, within one standard deviation of the mean. Moderate-fermenting fibers include, without limitation, beet root or beet fiber, konjac root, longer chain or more structurally complex variants of fast-fermenting fibers, and a subset of fibers present in whole foods with a diverse matrix of dietary fibers, as well as fibers having physicochemical features and/or rates of fermentation similar thereto. Fermentation of moderate-fermenting fibers tends to occur in areas between the most proximal extent of fermentation of fast-fermenting fibers and the most distal extent of slow-fermenting fibers, for example, in the middle colon.

As used herein, dietary fibers are categorized as fast-fermenting, moderate-fermenting, or slow-fermenting based on their relative fermentation behavior within the gastrointestinal tract, as determined by comparison to recognized exemplar fibers and their predominant sites of fermentation, without requiring strict numerical cutoffs.

In some embodiments, the fibers of the fiber blend compositions disclosed herein are prebiotics, including but not limited to, inulin, one or more fructo-oligosaccharides (FOS), one or more galacto-oligosaccharides (GOS), one or more disaccharides, one or more monosaccharides, one or more polyols, one or more sugar alcohols, oligofructose, or a combination of two or more prebiotics.

As used herein, the term “non-fast-fermenting fibers” encompasses slow-fermenting fibers and moderate-fermenting fibers. In some embodiments of the full-spectrum or complete fiber blend as described herein, one or more non-fast-fermenting fibers are combined with one or more fast-fermenting fibers. Combinations of one or more non-fast-fermenting fibers with one or more fast-fermenting fibers can be beneficially administered to companion mammals, for example, to improve gut health, provide better nutrition, reduced gastrointestinal dysbiosis, and support general health.

Without being bound by theory, it is believed that the administration of a combination of one or more fast-fermenting fibers and one or more non-fast-fermenting fibers provides for fermentation over a larger and more distal extent (i.e. more, and more distal. locations) of the intestine than for administration of only fast-fermenting fiber(s). By combining at least one type of fast-fermenting fiber and at least one type of non-fast-fermenting fiber, the beneficial effects of fiber on the microbiota can be realized over a greater area of the GI tract with potentially greater benefits for nutrition, reduced dysbiosis and improved general health relative to administration of only fast-fermenting fibers. Negative side effects such as gas, bloating or discomfort may also be reduced, for example, insofar as such combination may permit administration of a lower amount of fast-fermenting fiber than for administration of fast-fermenting fiber only and/or as fermentation happens over a larger amount of area and time and/or is more effective in generating SCFAs.

In some embodiments of the full-spectrum or complete fiber blend as described herein, one or more slow-fermenting fibers are combined with one or more moderate-fermenting fibers. In some embodiments of the full-spectrum or complete fiber blend as described herein, one or more slow-fermenting fibers are combined with one or more moderate-fermenting fibers and one or more fast-fermenting fibers. Combinations of one or more slow-fermenting fibers with one or more moderate-fermenting fibers, in some embodiments further comprising one or more fast-fermenting fibers, can be beneficially administered to companion mammals, for example, to improve gut health, provide better nutrition, reduced gastrointestinal dysbiosis, and support general health.

Without being bound by theory, it is believed that the administration of a combination of one or more slow-fermenting fibers and one or more moderate-fermenting fibers, optionally in combination with a fast-fermenting fiber, provides for fermentation over a larger and more distal extent of the intestine than for administration of only fast-fermenting fibers and/or only one type of non-fast-fermenting fibers. By such combinations, the beneficial effects of fiber on the microbiota can be realized over a greater area of the GI tract with potentially greater benefits for nutrition, reduced dysbiosis, and improved general health relative to administration of only fast-fermenting fibers. Negative side effects such as gas, bloating or discomfort may also be reduced, for example, insofar as such combination may exclude fast-fermenting fibers or permit administration of a lower amount of fast-fermenting fiber than for administration of fast-fermenting fiber only.

In some embodiments, the fiber blend has a combination of at least two fibers chosen from a slow-fermenting fiber, a moderate-fermenting fiber and a fast-fermenting fiber. In some embodiments, the fiber-blend composition comprises a slow-fermenting fiber, a moderate-fermenting fiber and a fast-fermenting fiber. In some embodiments, the fiber-blend composition comprises three types of fiber, wherein the fibers ferment at different rates so the benefits span the entire GI tract of the animal. The slow fermenting fiber can be any chosen from the group: bran, arabinogalactan (e.g., larch tree arabinogalactan), longer-chain version of fast-fermenting fiber, and fermented components thereof. The moderate-fermenting fibers can be any chosen from the group: one or more fibers derived from pumpkin, konjac root, fibers derived from beetroot, and fermented components thereof. The fast-fermenting fiber can be any chosen from the group: one or more fructo-oligosaccharides (FOS), galacto-oligosaccarides (GOS), mannan-oligosaccharides (MOS), psyllium, pectin, chicory root, Jerusalem artichoke, inulin, and combinations thereof.

In some embodiments, the fiber blend as described herein comprises arabinogalactan (e.g., larch tree arabinogalactan), beets (e.g., beet root or beet fiber), and one or more mannan-oligosaccharides (MOS). In some embodiments, the fiber blend as described herein comprises larch tree arabinogalactan, beets, and mannan-oligosaccharides (MOS). In one embodiment, the fiber blend as described herein consists of larch tree arabinogalactan, beets, and mannan-oligosaccharides (MOS).

In some embodiments, the full-spectrum or complete fiber blend as described herein comprises bran (e.g., wheat, corn, rick, rye), beets (e.g., beet root or beet fiber), and one or more mannan-oligosaccharides (MOS), or variants thereof. In some embodiments, the full-spectrum or complete fiber blend as described herein comprises a resistant starch (e.g., green banana), beets (e.g., beet root or beet fiber), and one or more mannan-oligosaccharides (MOS), or variants thereof.

In some embodiments, the fiber blend as described herein comprises arabinogalactan (e.g., larch tree arabinogalactan), beets (e.g., beet root or beet fiber), and one of more of: psyllium (e.g., psyllium husk), fructo-oligosaccharides (FOS), galacto-oligosaccarides (GOS), one or more mannan-oligosaccharides (MOS), inulin, pectin, betaglucans, and a plant-derived fiber, e.g., fiber from chicory root, Jerusalem artichoke, apple, dandelion, or the like, or variants thereof.

In some embodiments, the fiber blend as described herein comprises arabinogalactan (e.g., larch tree arabinogalactan), konjac root, and one or more mannan-oligosaccharides (MOS), or variants thereof. In some embodiments, the fiber blend as described herein comprises arabinogalactan (e.g., larch tree arabinogalactan), a longer-chain fast-fermenting fiber, and one or more mannan-oligosaccharides (MOS), or variants thereof.

In some embodiments, the fiber blend comprises three different fibers that ferment at different rates and/or for which (i) fermentation of at least one of the fibers occurs in proximal regions of the intestine suitable for fermentation, e.g., the distal extent of the small intestine and/or upper colon, and (ii) fermentation of at least one of the fibers occurs in distal regions of the intestine suitable for fermentation, e.g., the middle or lower colon.

In some embodiments, the fiber blend as described herein comprises arabinogalactan (e.g., larch-derived arabinogalactan) and beets (e.g., beet root or beet fiber). In some embodiments, the fiber blend as described herein comprises bran (e.g., wheat, corn, rick, rye) and one or more of arabinogalactan (e.g., larch-derived arabinogalactan), longer chain versions of fast-fermenting fibers, resistant starches (e.g., green banana), longer chain versions of fast-fermenting fibers, and konjac root. In some embodiments, the fiber blend as described herein comprises longer chain versions of fast-fermenting fibers and/or konjac root, and one or more of bran (e.g., wheat, corn, rick, rye), resistant starches (e.g., green banana), and/or arabinogalactan (e.g., larch-derived arabinogalactan). In some embodiments, the fiber blend can be provided for administration in conjunction with a fast-fermenting fiber product.

In some embodiments, the fiber blend comprises two fibers that ferment at different rates and for which (i) fermentation of at least one of the fibers occurs in mid-regions of the intestine suitable for fermentation, e.g., the upper and/or middle colon, and (ii) fermentation of at least one of the fibers occurs in distal regions of the intestine suitable for fermentation, e.g., the middle and/or lower colon.

In some embodiments, the fiber blend compositions disclosed herein further comprise one or more components being provided in a form or with an excipient that enhances stability of the product and/or survival through the gastrointestinal tract if administered orally (e.g., an enteric coating, microencapsulation, etc.).

In some embodiments, the fiber blend compositions disclosed herein further comprise an acceptable carrier. As used herein, a “carrier” includes any solvent, dispersion medium, vehicle, coating, diluent, isotonic agent, absorption delaying agent, buffer, carrier solution, suspension, colloid, and the like. As used herein, “acceptable” refers to a material that is not biologically or otherwise undesirable, i.e. the material may be administered to an individual along with the fiber blends without causing any undesirable biological effects or interacting in a deleterious manner with any of the other components of the composition in which it is contained.

In some embodiments, the fiber blend compositions comprise supplementary ingredients, such as flavoring, sweeteners, or food. For example, in some embodiments, the fiber blend compositions are provided in combination with a food, for example, pre-mixed with a commercial food or as a supplemental food item, e.g., as a component of a treat.

The fiber blend compositions disclosed herein may be provided in any suitable form including but not limited to a solid (e.g., a powder or tablet), a solution, a liquid suspension, a gel, an emulsion, a spray, an aerosol, or any form of mixture. The fiber blend compositions may be delivered in formulation with any pharmaceutically acceptable excipient, carrier, or vehicle.

A fiber blend composition as disclosed herein can be administered via known routes including, for example, oral. In some embodiments, the fiber blend compositions disclosed herein are formulated in one of a variety of forms adapted to a route of administration, for example, oral administration. Thus, for example, the fiber blend compositions described herein may be formulated, for example, as a powder, tablet, capsule, pill, packet, dissolvable capsule, liquid suspension, and the like. In an embodiment, the composition is formulated for delivery in a conventional oral dosage form, for example, a powder, for example, a powder suitable for sprinkling on food or otherwise being combined with food or consumable liquid.

Administration of a fiber blend composition as disclosed herein, including but not limited to a fiber blend composition comprising a slow-fermenting fiber, a moderate-fermenting fiber and a fast-fermenting fiber, provides improvement in the gastrointestinal health of companion mammals (e.g., cats and/or dogs) including reduced symptoms of dysbiosis, for example, reduced frequency of abnormal stool, improved stool consistency, and improved bowel regularity.

Thus, disclosed herein is a method of supporting gastrointestinal health in a companion animal by administering an effective amount of a fiber blend composition as disclosed herein. In an embodiment, the fiber blend composition comprises a powdered formulation and is administered by application to or mixing with food. The composition can be formulated and administered as a unit-dose dietary supplement, e.g., according to a scoop having a particular volume or in unit-dose packets.

In some embodiments, the method comprises administering a fiber blend composition comprising at least two fibers chosen from a slow-fermenting fiber, a moderate-fermenting fiber and a fast-fermenting fiber, for example, a slow-fermenting fiber and a moderate-fermenting fiber. In some embodiments, the method comprises administering a fiber blend composition comprising a slow-fermenting fiber, a moderate-fermenting fiber and a fast-fermenting fiber. In some embodiments, the method comprises administering a fiber blend composition comprising larch tree arabinogalactan, beetroot, and mannan-oligosaccharides (MOS).

In some embodiments, described herein is a method of supporting, for example, improving and/or maintaining (e.g., preventing decline of), gastrointestinal health in a companion animal comprising identifying an animal having or at risk of having a gut health disorder, and administering to the animal a predetermined dosage of a fiber blend composition as disclosed herein. In some embodiments, the gut health related disorder is chosen from diarrhea, loose stool, constipation, hairballs, anal gland issues, other dysbiotic conditions, or a combination thereof, to name a few.

As used herein, the term “and/or” means one or all of the listed elements or a combination of any two or more of the listed elements; the terms “comprises,” “comprising,” and variations thereof are to be construed as open ended—i.e. additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

As used herein, “have,” “has,” “having,” “include,” “includes,” “including,” “comprise,” “comprises,” “comprising” or the like are used in their open-ended inclusive sense, and generally mean “include, but not limited to,” “includes, but not limited to,” or “including, but not limited to.” Further, wherever embodiments are described herein with the language “have,” “has,” “having,” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

As used herein, “exemplary” means to serve as an illustrative example and should not be construed as preferred or advantageous over other embodiments.

In the preceding description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In the above description, guidance may be provided through lists of examples, which examples can be used in various combinations. In each instance, the recited list serves only as a representative group and should not be interpreted as an exclusive list.

### EXAMPLES

The invention is further described in detail by reference to the following examples. These examples are provided for purposes of illustration only and are not intended to be limiting unless otherwise specified. Thus, the invention should in no way be construed as being limited to the following examples, but rather should be construed to encompass any and all variations that become evident as a result of the teaching provided herein.

### Example 1—Composition of an Exemplary Fiber Blend

A fiber blend composition comprising dehydrated beet pulp powder, larch tree fiber/arabinogalactans, and mannan-oligosaccharides (MOS) derived from coconuts is described herein.

The ranges for each of the aforementioned ingredients, in a composition as disclosed herein, are: mannan-oligosaccharides (MOS): 5-10% by weight of the fiber content of the composition; larch tree fiber/arabinogalactan: 40-50% by weight of the fiber content of the composition; and dehydrated beet pulp powder: 40-50% by weight of the fiber content of the composition.

In an exemplary embodiment, the three fiber ingredients were blended in the following proportions:

TABLE 1
Composition of an exemplary fiber blend

| Ingredient | Amount |
|---|---|
| Dehydrated Beet Pulp Powder | 470 mg |
| Larch Tree Fiber/Arabinogalactan | 450 mg |
| Mannan-oligosaccharides (MOS) | 80 mg |

### Example 2—Dosing in Cats and Dogs

Based on the bodyweight of cats and dogs, the three fiber blend disclosed in Example 1 was administered to cats and to dogs having a gut-related disorder according to the following proportions:

TABLE 2
Body weight-based dosing for cats

| | |
|---|---|
| Recommended | Amount of Each Ingredient |

| | | | | |
|---|---|---|---|---|
| Cats | Daily Amount | MOS | Beet | Larch |

| | | | | | | |
|---|---|---|---|---|---|---|
| <5 | lbs | 333 | mg/day | 27 | 157 | 150 |
| 5-10 | lbs | 666 | mg/day | 53 | 313 | 300 |
| 10+ | lbs | 1 | g/day | 80 | 470 | 450 |

TABLE 3
Body weight-based dosing for dogs

| | |
|---|---|
| Recommended | Amount of Each Ingredient |

| | | | | |
|---|---|---|---|---|
| Dogs | Daily Amount | MOS | Beet | Larch |

| | | | | | | |
|---|---|---|---|---|---|---|
| <10 | lbs | 333 | mg/day | 27 | 157 | 150 |
| 10-15 | lbs | 666 | mg/day | 53 | 313 | 300 |
| 15-30 | lbs | 1 | g/day | 80 | 470 | 450 |
| 30-50 | lbs | 1.7 | g/day | 133 | 783 | 750 |
| 50-75 | lbs | 2 | g/day | 160 | 940 | 900 |
| 75 | lbs+ | 3 | g/day | 240 | 1410 | 1350 |

### Example 3—In-Home Study

An in-home evaluation was conducted to assess the effects of the fiber blend composition described in Example 1 (marketed as Animal Biome Complete Fiber Blend and referred to herein as CFB) on gastrointestinal health in dogs and cats.

The study included 65 dogs and 42 cats, each at least one year of age, consuming commercially available diets, and not previously administered the fiber blend. These animals were administered the fiber blend daily for 30 days, according to bodyweight-based dosing guidelines described in Example 2.

Prior to administration, pet owners completed a baseline survey regarding stool consistency, bowel regularity, and gastrointestinal symptoms. Fecal samples were collected at baseline and again at day 30 for gut microbiome assessment using commercially available testing kits. At day 30, pet owners completed a follow-up survey evaluating stool consistency (with reference to a provided fecal scoring chart providing reference categories ranging from watery to very hard/dry, available at https://vetcentre.purina.co.uk/sites/default/files/2021-11/Faecal % 20scoring %20chart_general %20use.pdf), bowel regularity, appetite, weight, and other gastrointestinal-related observations.

Cat participants (43.9% female; 56.1% male) had a mean age of 7.5 years (range 2 to 19 years), a mean body condition score of 4.4 (range 2 to 8), and a mean body weight of 11.3 lbs. (range 6.5 to 21 lbs.). Diets included raw (22%), raw_wet (12.2%), kibble_wet (24.4%) and other (42.5%). Breeds were DSH (31.7%), DLH/DMH (17.1%), ASH (34.1%) and other (17.1%). Most (58.5%) did not have an identified condition and 24.4% had IBD.

Dog participants (42.6% female; 57.4% male) had a mean age of 7.6 years (range 1 to 18 years), a mean body condition score of 4 (range 2 to 6), and a mean body weight of 36.2 lbs. (range 6 to 136 lbs.). Diets included raw (23%), cooked (21.3%), raw and cooked (18%), and other (37.7%). Breeds were Toy (9.8%), Terrier (16.4%), Retriever (8.2%), Poodle mix (11.5%), and other (54.1%). More than half (52.5%) did not have an identified condition, 9.8% had IBD, and 13.1% had a skin condition.

Collection of fecal material from dog participants was done using and according to the DoggyBiome™ Gut Microbiome Health Test, while collection of fecal material from cat participants was done using and according to the KittyBiome™ Gut Microbiome Health Test (each available from AnimalBiome).

### Example 4—In-Home Study Results (Stool)

Administration of the fiber blend composition for 30 days was well tolerated in both dogs and cats. The majority of participants showed no adverse effects, with appetite and body weight remaining stable throughout the study period.

Animals with normal stool consistency at baseline generally maintained normal stool consistency throughout the study and no significant changes were observed.

Among animals presenting with abnormal stool consistency at baseline (including diarrhea, soft stools, or constipation), improvements in stool consistency were observed. Animals exhibiting soft stool at baseline may experience improvements in fecal consistency due to changes in microbial metabolic activity, substrate utilization, or community structure, even in the absence of measurable increases in overall species richness (see Examples 7 and 8 below). Such improvements were more pronounced in dogs, with many achieving ideal stool consistency during the study period. For 14 dogs and 9 cats that began the study with diarrhea or soft stools, about ⅓ of the cats and almost ¾ of the dogs had ideal stool consistency at day 30. The effect was highly significant for dogs (McNemar's test p=0.004 for dogs), but not statistically significant for cats, probably due to the lower sample size. For 3 dogs and 6 cats that began the study with constipation, ⅓ cats and 6/6 (i.e. all) dogs had ideal stool consistency at day 30. Due to low sample sizes, these results were not statistically significant. In some animals, improvements in fecal consistency were observed without corresponding increases in microbial species richness (see Examples 7 and 8 below). This suggests that clinical benefits may arise from functional or compositional shifts within the microbial community that are not fully captured by richness metrics alone, particularly in animals exhibiting soft stool at baseline.

Survey results relating to stool consistency for animals presenting with diarrhea or soft stools, and separately for those presenting with constipation, are shown in Table 4 below. Improvements in stool consistency occurred more commonly for dogs and animals presenting with soft stools than for cats presenting with constipation.

TABLE 4
Stool Survey Results for Dysbiotic Animals

| Initial | No change | | Softer | | Firmer | |
|---|---|---|---|---|---|---|
| Condition | Cats | Dogs | Cats | Dogs | Cats | Dogs |
| Diarrhea or | 44.5% | 63% | 11% | 0% | 44.5% | 37% |
| Soft Stools | | | | | | |
| Constipation | 60% | 33% | 0% | 33% | 40% | 33% |

Improvements in bowel regularity were reported in a subset of animals with baseline irregularity (data not shown). Additionally, pet owners reported improvements in gastrointestinal-associated behaviors, including reduced scooting or anal gland-related behaviors in dogs and reduced hairball regurgitation in cats.

Among animals presenting with abnormal stool consistency at baseline (including diarrhea, soft stools, or constipation), general “improvement” in symptoms were reported for 29% of the cats and 71% of the dogs that were evaluated. The owners of many animals provided testimonials describing the symptoms of their dog or cat at the beginning of the study and the manner in which symptoms were improved, including many who noted reduction in the frequency of episodes of abnormal stool, as well as more normal stool consistency.

These results demonstrate that the fiber blend composition provides gastrointestinal support through dietary fiber fermentation characteristics rather than through administration of live microorganisms.

### Example 6—In-Home Study Results (Microbiome)

Analysis of fecal samples indicated that administration of the fiber blend did not disrupt overall gut microbiome diversity, consistent with a gentle and well-tolerated dietary fiber intervention.

The microbiomes of some of the animals receiving the fiber composition included harmful bacteria such as Escherichia coli and Streptococcus lutetiensis when the study began (i.e. at baseline). The relative abundance of E. coli decreased from baseline to day 30 in 23 such study participants. The relative abundance of S. lutetiensis decreased from baseline to day 30 in 26 such study participants.

The microbiome of 61% of the dog participants included harmful bacteria at the beginning of the study. Of these 61%, more than third (38%) eradicated the harmful bacteria (i.e. had no harmful bacteria in their microbiome at day 30). Of the 39% whose microbiome did not include harmful bacteria at the beginning of the study, 92% continued to have microbiomes free of harmful bacteria at day 30.

The microbiome of only 30% of the cat participants included harmful bacteria at the beginning of the study. Of these 30%, half eradicated the harmful bacteria (i.e. had no harmful bacteria in their microbiome at day 30). Of the 70% whose microbiome did not include harmful bacteria at the beginning of the study, 89% continued to have microbiomes free of harmful bacteria at day 30.

### Example 7—In Vitro Evaluation of Dietary Fiber Combinations on Microbial Communities

Stool-derived microbial communities were evaluated using an in vitro colonic fermentation model to assess the effects of dietary fiber combinations on microbial composition over time. Three dietary fibers, (mannan-oligosaccharides (MOS) (“M”), dehydrated beet pulp fiber (“B”), and larch-derived arabinogalactan (“L”)) were tested individually and in all possible combinations (B, L, M, B+L, B+M, L+M, B+L+M).

Fiber amounts were selected to approximate, on a relative mass basis, the range of fiber exposures anticipated in the target companion animal host (i.e. dog) following administration of the corresponding formulations. Stool-derived microbial communities were incubated in vitro with fiber quantities scaled to the amount of stool present in each culture, such that the ratio of fiber to microbial biomass was designed to be directionally consistent with in vivo dosing while avoiding supraphysiologic fiber loads.

Three stool samples were collected from dogs who were reported to have soft stool. For each stool sample, fiber formulations were combined with stool under anaerobic conditions suitable for microbial growth. Baseline samples were collected prior to incubation. Additional samples were collected following incubation for approximately 24 hours, 48 hours, and 72 hours. Samples were preserved by freezing and subsequently processed for nucleic acid extraction and 16S IRNA gene sequencing. See Rojas, C. A., et al. 2024. “Species-level characterization of the core microbiome in healthy dogs using full-length 16S rRNA gene sequencing.” Frontiers in Veterinary Science, 11, p. 1405470 (incorporated herein by reference). Microbial community composition was assessed at each time point, and species richness was calculated based on detected operational taxonomic units (OTUs).

### Example 8—In Vitro Study Results

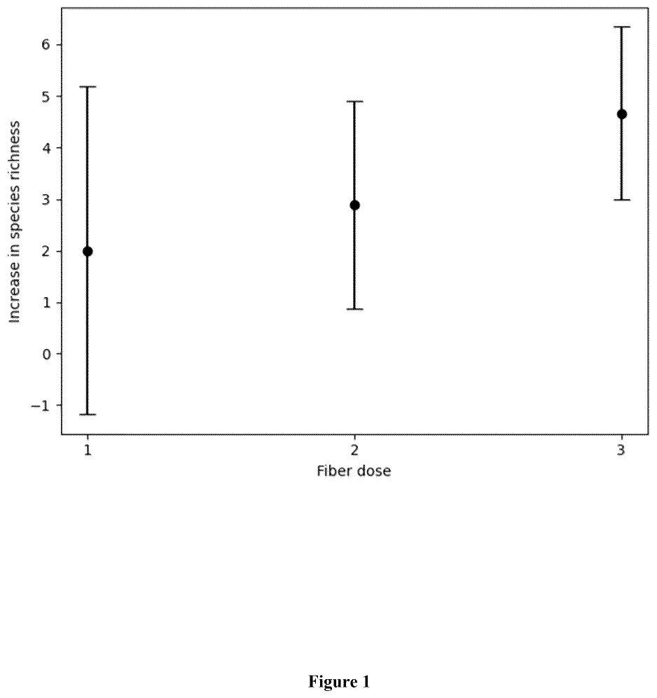

In stool-derived microbial communities exhibiting reduced baseline diversity, formulations comprising multiple dietary fibers produced greater early increases in microbial species richness compared to single-fiber formulations, as shown in FIG. 1. These increases were observed within the first 24 hours of incubation and were not attributable to expansion of a single dominant taxon. Results were consistent across the three timepoints (T24, T48, T72).

Instead, the increase in species richness resulted from the emergence of multiple low-abundance taxa that were undetectable at baseline and became detectable following incubation, including members of anaerobic bacterial lineages associated with complex carbohydrate metabolism. This effect occurred despite modest or variable changes in the relative abundance of individual taxa and did not follow a linear or additive relationship with increasing fiber complexity.

Unexpectedly, increasing fiber complexity was associated with a trend toward reduced inter-sample variability in early species richness responses, as reflected by decreasing dispersion around the mean with increasing fiber number (for example, SEM values of approximately 3.18 for one fiber, 2.0 for two fibers, and 1.67 for three fibers), as shown in FIG. 1. This suggests that multi-fiber formulations may not only enhance community expansion but also stabilize outcomes across heterogeneous microbial inputs.

Analysis of operational taxonomic units revealed that multiple taxa were undetectable at baseline but became detectable within 24 hours of incubation. These newly detected taxa included members of Clostridia, Bacilli, Bacteroidota, Actinobacteriota, and Proteobacteria, indicating distributed community expansion rather than overgrowth of a single taxonomic group.

Accordingly, multi-fiber formulations promoted distributed community expansion characterized by the appearance of numerous taxa at low relative abundance, resulting in higher overall species richness without dominance by any single organism.

In stool-derived microbial communities exhibiting reduced baseline diversity, incubation in the absence of dietary fiber resulted in greater depletion of Lachnospiraceae and Ruminococcaceae during early incubation. In contrast, formulations comprising one or more dietary fibers reduced the magnitude of this depletion. When normalized to a no-fiber control, multi-fiber formulations produced greater preservation of these taxa than single-fiber formulations, with intermediate fiber complexity frequently providing the greatest effect. These results indicate that fiber combinations mitigate early loss of key anaerobic taxa during community expansion rather than promoting overgrowth of individual organisms. Results were consistent across the three timepoints (T24, T48, T72).

The foregoing detailed description and examples have been given for clarity of understanding only. No unnecessary limitations are to be understood therefrom. The invention is not limited to the exact details shown and described, for variations obvious to one skilled in the art will be included within the invention defined by the claims. All headings are for the convenience of the reader and should not be used to limit the meaning of the text that follows the headings.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Values expressed in a range format should be interpreted in a flexible manner to include the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” and the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt).

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern.

1. A dietary fiber composition for a companion animal, comprising:
(a) at least one fast-fermenting dietary fiber;
(b) at least one moderate-fermenting dietary fiber; and
(c) at least one slow-fermenting dietary fiber;
wherein the at least one fast-fermenting dietary fiber, the at least one moderate-fermenting dietary fiber, and the at least one slow-fermenting dietary fiber are each characterized by a fermentation rate and/or a location of fermentation along the gastrointestinal tract of the companion animal; and
wherein the at least one fast-fermenting dietary fiber, the at least one moderate-fermenting dietary fiber, and the at least one slow-fermenting dietary fiber differ in their fermentation rates and/or their locations of fermentation.

2. The dietary fiber composition of claim 1, wherein
the slow-fermenting fiber is selected from larch-derived arabinogalactan, bran, resistant starches, and combinations thereof.

3. The dietary fiber composition of claim 2, wherein
the moderate-fermenting fiber is selected from beet-derived fiber, konjac root fiber, longer-chain versions of fast-fermenting fiber, and combinations thereof.

4. The dietary fiber composition of claim 3, wherein
the fast-fermenting fiber is selected from fructo-oligosaccharides, galacto-oligosaccharides, mannan-oligosaccharides, psyllium, pectin, chicory root, betaglucans, Jerusalem artichoke, inulin, and combinations thereof.

5. The dietary fiber composition of claim 1, wherein:
(a) the at least one fast-fermenting dietary fiber comprises mannan-oligosaccharides (MOS);
(b) the at least one moderate-fermenting dietary fiber is a beet-derived fiber; and
(c) the at least one slow-fermenting fiber is arabinogalactan and/or an extract of larch tree.

6. The dietary fiber composition of claim 5, wherein
the arabinogalactan is larch tree arabinogalactan.

7. The dietary fiber composition of claim 5, wherein:
(a) the mannan-oligosaccharides are present in an amount of about 5 wt % to about 15 wt %;
(b) the beet-derived fiber is present in an amount of about 35 wt % to about 55 wt %; and
(c) the arabinogalactan is present in an amount of about 35 wt % to about 55 wt %.

8. The dietary fiber composition of claim 1, wherein
the composition further comprises a pharmaceutically acceptable carrier or excipient.

9. The dietary fiber composition of claim 1, wherein
the composition comprises a formulation suitable for mixing or mixed with food.

10. The dietary fiber composition of claim 9, wherein
the composition is formulated as a unit-dose dietary supplement.

11. The dietary fiber composition of claim 1, wherein
the companion animal is a dog.

12. The dietary fiber composition of claim 1, wherein
the companion animal is a cat.

13. The dietary fiber composition of claim 1, wherein
the composition is free of pumpkin-derived fiber.

14. A method of supporting gastrointestinal health in a companion animal, comprising administering to the companion animal an effective amount of the dietary fiber composition of claim 1.

15. The method of claim 14, wherein
the dietary fiber composition is administered daily.

16. The method of claim 14, wherein
the effective amount of the dietary fiber composition is about 0.3 g to about 3 g per daily dose, based on body weight of the companion animal.

17. The method of claim 14, wherein
the dietary fiber composition is administered in combination with food.

18. The method of claim 16, wherein
administration of the dietary fiber composition supports stool consistency in the companion animal.

19. The method of claim 18, wherein
the companion animal is a dog.

20. The method of claim 16, wherein
administration of the dietary fiber composition supports bowel regularity in the companion animal.

21. The method of claim 16, wherein
the dietary fiber composition maintains or promotes taxonomic richness of the gastrointestinal microbiome.

22. A dietary fiber composition for a companion animal, comprising:
at least two of: a fast-fermenting dietary fiber, a moderate-fermenting dietary fiber, and a slow-fermenting dietary fiber;
wherein the fast-fermenting dietary fiber, the moderate-fermenting dietary fiber, and the slow-fermenting dietary fiber are each characterized by a fermentation rate; and
wherein the fast-fermenting dietary fiber, the moderate-fermenting dietary fiber, and the slow-fermenting dietary fiber differ in their fermentation rates;
wherein, in an in vitro stool assay, fermentation with the dietary fiber composition produces higher microbial species richness relative to an otherwise identical composition comprising only one of the fast-fermenting dietary fiber, the moderate-fermenting dietary fiber, and the slow-fermenting dietary fiber.

23. The dietary fiber composition of claim 22, further comprising:
(a) at least one fast-fermenting dietary fiber;
(b) at least one moderate-fermenting dietary fiber; and
(c) at least one slow-fermenting dietary fiber.

24. The dietary fiber composition of claim 22, wherein
the composition is free of pumpkin-derived fiber.

25. A method of modulating a gastrointestinal microbiome in a companion animal, comprising administering to the companion animal an effective amount of the dietary fiber composition of claim 22.

26. The method of claim 25, wherein
the dietary fiber composition further comprises:
(a) at least one fast-fermenting dietary fiber;
(b) at least one moderate-fermenting dietary fiber; and
(c) at least one slow-fermenting dietary fiber.

27. The method of claim 26, wherein
the dietary fiber composition is administered daily.

28. The method of claim 26, wherein
the effective amount of the dietary fiber composition is about 0.3 g to about 3 g per daily dose, based on body weight of the companion animal.

29. The method of claim 25, wherein
in an in vitro stool assay, fermentation with the dietary fiber composition results in higher relative abundance of Lachnospiraceae and/or Ruminococcaceae relative to an otherwise identical composition comprising no dietary fiber.

30. The method of claim 25, wherein
companion animal is a dog or a cat.
